(19) United States
(12) Patent Application Publication
(10) Pub. No.: US 2026/0205694 A1
(43) Pub. Date: Jul. 16, 2026

(54) IMAGE CAPTURING APPARATUS AND CONTROL METHOD THEREFOR

(71) Applicant: CANON KABUSHIKI KAISHA, Tokyo (JP)

(72) Inventor: YUICHI HIRAI, Tokyo (JP)

(21) Appl. No.: 19/429,382

(22) Filed: Dec. 22, 2025

(30) Foreign Application Priority Data
Jan. 14, 2025 (JP) 2025-004818

(51) Int. Cl. H04N 23/68; H04N 23/63

(52) U.S. Cl. CPC H04N 23/683; H04N 23/635

(57) ABSTRACT

An image capturing apparatus capable of correcting image blur in an image captured by an image capturing device includes: at least one memory storing instructions and at least one processor executing the stored instructions to: control image-blur correction by changing a cut-out region of an image on an imaging plane of the image capturing device based on a detection signal from a detection unit detecting a change in position or orientation of the image capturing apparatus, the captured image, or both; in a case where, due to the image-blur correction control, an out-of-imaging region intrudes into an image region corresponding to an angle of view, process information used when notifying or recording the intrusion of the out-of-imaging region; and control to output of the information processed with respect to the recorded angle of view according to a strength of the correction, to a display unit, or a recording unit.

### BACKGROUND

### Field of the Technology

The present disclosure relates to a technology for correcting image blur in image by image processing.

### Description of the Related Art

Image blur correction based on image processing with respect to a captured image (hereinafter, also referred to as “electronic image stabilization”) is a technology for controlling a cut-out position of the captured image so as to correct image blur that is caused by motion of an image capturing apparatus. For example, in a case in which the cut-out position is changed for each frame of a moving image, , it is necessary to perform cutting out of the image after distortion correction in view of aberration correction of the lens, such that a moving image having no unnaturalness in a time series can be obtained.

Japanese Patent Laid-Open No. 2005-252626 discloses a technology for correcting distortion aberration in an imaging optical system and for performing electronic image stabilization correction. The image capturing apparatus includes a conversion unit that performs a projective transformation process on fisheye image data that has been obtained by an image sensor into perspective projection image data, and performs shake correction unit that shifts a region to be output within the perspective projection image data based on vibration information that has been detected by a shake detection unit.

In an image capturing apparatus having an electronic image stabilization function, for example, in order to move a cut-out position of a recorded image so as to cancel shaking of the image capturing apparatus after performing correction such as image distortion correction by a geometric transformation process, a certain margin (allowance region) is required in a peripheral portion of an image region. This margin is determined in consideration of shaking of the image capturing apparatus. In a case in which the margin is reduced, there is a possibility that a region having no effective pixels may occur within a cut-out angle of view when shaking of the image capturing apparatus is large. Therefore, there is a method of interpolating, for a region having no effective pixels, using preceding and succeeding frame images, and a method of performing interpolation of an image region by using generative artificial intelligence (AI). By performing image interpolation on a no-image region that has occurred within a cut-out angle of view in processing based on electronic image stabilization control (hereinafter also referred to as “electronic image stabilization processing”), it is possible to relax conditions for margin management and to widen an allowable range regarding changes in electronic image stabilization strength.

However, in a case in which frame images including interpolated image regions continue for a certain period of time, there is a possibility that the image quality will deteriorate. A unit for checking an insufficient margin condition is effective in a case in which the user would like to actively reflect an image on an imaging plane in a recorded image by making changes in the electronic image stabilization strength made possible. For that purpose, it is effective to provide information that enables a user to grasp a recorded image on which electronic image stabilization processing has been performed, together with an intrusion state of an out-of-imaging region (no-image region) into an image region corresponding to a recorded angle of view, so that an appropriate electronic image stabilization strength can be selected.

### SUMMARY

The present disclosure is directed to provide information for notifying or recording an intrusion state of an out-of-imaging region into an image region that corresponds to a recorded angle of view in image blur correction based on image processing.

An image capturing apparatus according to an aspect of the present disclosure is capable of correcting image blur in an image captured by an image capturing device, and includes: at least one memory storing instructions; and at least one processor executing the stored instructions causing the image capturing apparatus to: perform control of image-blur correction by changing a cut-out region of an image on an imaging plane of the image capturing device based on at least one of a detection signal from a detection unit configured to detect a change in position or orientation of the image capturing apparatus, and the image captured by the image capturing device; in a case in which, as a result of the control of the image-blur correction, an out-of-imaging region is included in an image region corresponding to a recorded angle of view, perform processing for information used when notifying intrusion of the out-of-imaging region into the image region, or when recording the intrusion of the out-of-imaging region into the image region; and perform control to output, to a display unit, or a recording unit, the information that has been processed with respect to the recorded angle of view according to a strength of the image-blur correction.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a system configuration of an image capturing apparatus according to an embodiment.

FIG. 2A and FIG. 2B are diagrams illustrating a relation between electronic image stabilization strength and a recorded angle of view in the embodiment.

FIG. 3 is a flowchart illustrating overall control of the image capturing apparatus in the embodiment.

FIG. 4 is a flowchart illustrating overall control of the image capturing apparatus, continuing from FIG. 3.

FIG. 5 is a flowchart illustrating moving image standby processing in the embodiment.

FIG. 6 is a flowchart illustrating moving-image recording processing in the embodiment.

FIG. 7 is a flowchart illustrating moving image playback display processing in the embodiment.

FIG. 8 is a flowchart illustrating geometric transformation/image blur correction processing in the embodiment.

FIG. 9 is a flowchart illustrating processes after FIG. 8.

FIG. 10 is a flowchart illustrating incomplete information processing in the embodiment.

FIG. 11 is a flowchart illustrating processes after FIG. 10.

FIG. 12A and FIG. 12C are diagrams illustrating examples of notification to a user by monitor display.

FIG. 13 is a diagram illustrating an effect of timeline display in an editing tool.

FIG. 14 is a flowchart illustrating moving image external recording processing in the embodiment.

### DESCRIPTION OF THE EMBODIMENTS

Hereinafter, embodiments of the present disclosure will be explained in detail with reference to the accompanying drawings. In the present embodiment, in an image capturing apparatus capable of changing an angle of view related to a strength setting of electronic image stabilization control, an example will be described in which it is possible to set the electronic image stabilization strength in a plurality of stages. For example, a cut-out angle of view of a recorded image with respect to an imaging plane of an imaging element is set in three stages of 90%, 70%, and 50%. With respect to the imaging angle of view, a 90% cut-out angle of view is denoted as an “angle of view A,” a 70% cut-out angle of view is denoted as an “angle of view B,” and a 50% cut-out angle of view is denoted as an “angle of view C.” A user can select and set the electronic image stabilization strength corresponding to the angle of view from a menu display screen (not illustrated). It is to be noted that, in an image capturing apparatus having an electronic image stabilization function based on image processing of a captured image, “image stabilization” refers to image blur correction in which image blur in an image that is caused by, for example, shaking or swaying of the image capturing apparatus, is corrected.

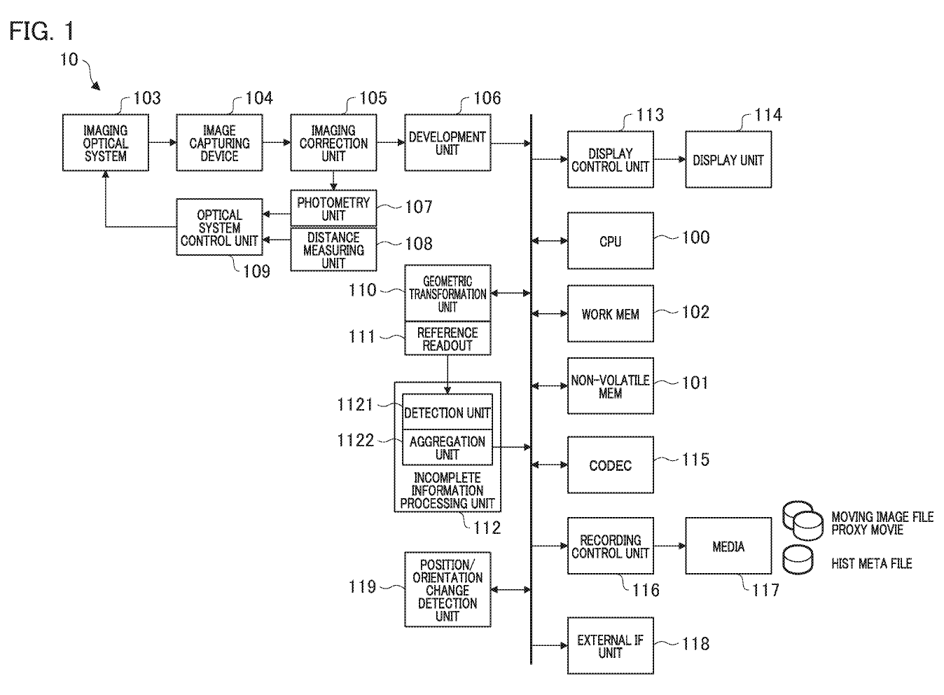

FIG. 1 is a block diagram illustrating an example of a system configuration of an image capturing apparatus 10 according to the present embodiment. A central processing unit (CPU) 100 performs overall control of the image capturing apparatus 10. The CPU 100 executes various processes by executing programs stored in a nonvolatile memory 101. A work memory 102 is a high-speed accessible memory, and a large capacity dynamic random access memory (DRAM) is used. By expanding a part of programs in the nonvolatile memory 101 into the work memory 102 and executing the programs by the CPU 100 while accessing the work memory 102, speeding-up of the processing can be realized.

An imaging optical system 103 is configured by optical members and the like that are included in a lens unit that is fixed to a main body portion of the image capturing apparatus or in an exchangeable lens device that is attachable to the main body portion of the image capturing apparatus. For example, the imaging optical system 103 includes a plurality of lenses, diaphragm blades, a lens drive unit (such as an actuator), and a mechanical shutter. In a case in which a read only memory (ROM) (not illustrated) stores lens correction data, the lens correction data can be read out and used when necessary.

An image capturing device 104 includes an imaging element (image sensor) that performs photoelectric conversion of a subject image that has been formed through the imaging optical system 103 and outputs an image signal. The imaging element is configured by arranging a plurality of pixel portions in a two-dimensional array. Each pixel portion has, for example, a pupil-division configuration in order to realize an autofocus (AF) function of an on-image plane phase difference detection method, and has a pair or a plurality of pairs of photoelectric conversion elements. The image capturing device 104 is configured by a photoelectric conversion portion, a charge accumulation portion, a readout transistor, an analog-to-digital (AD) converting unit, and the like, and may include an interface portion for high-speed readout. Hereinafter, the interface is denoted as “IF.”

An imaging correction unit 105 performs signal processing with respect to an output of the image capturing device 104. The imaging correction unit 105 performs characteristic correction due to a circuit configuration of the image capturing device 104 and defective pixel correction based on correction information. By acquiring a correction coefficient using temperature attribute information, correction according to the situation can be performed.

A development unit 106 performs image processing for development with respect to an output of the imaging correction unit 105. This image processing is processing for reproducing the luminance and color of a subject from data after imaging correction. Noise reduction processing and processing for countermeasures against false color may also be performed. For example, conversion processing (gamma processing) for image recording into 10-bit, 8-bit, and the like may be performed with respect to digital data that has been acquired with 14-bit or 12-bit accuracy by the analog-to-digital (AD) converting unit.

A photometry unit 107 acquires frame data after imaging correction from the imaging correction unit 105 and acquires luminance distribution information for each region by performing, for example, block integration. Here, processing may be performed for selecting and determining, from a program diagram (not illustrated), a relation (shooting conditions) between an amount of received light, an aperture value, and a shutter speed in accordance with ISO sensitivity.

A distance measuring unit 108 performs range measurement from the image capturing apparatus 10 to a subject. The distance measuring unit 108 can perform in-focus determination of an object estimated to be a main subject. For example, an in-focus determination result can be obtained by a known method, by calculating a defocus amount of the imaging optical system 103 based on a plurality of pieces of pixel information acquired by a pupil divided imaging element employing an on-image plane phase difference detection method.

An optical system control unit 109 controls the imaging optical system 103 by acquiring necessary information from the photometry unit 107 and the distance measuring unit 108. For example, the optical system control unit 109 acquires an aperture value that has been determined by the photometry unit 107 and a defocus amount that has been calculated by the distance measuring unit 108, and transmits information such as a lens movement amount (and direction) of a focus lens and the like to a control unit included in the imaging optical system 103. For example, aperture control, AF control, and the like are performed by the optical system control unit 109 transmitting a control signal to a communication unit (not illustrated) that communicates with an exchangeable lens device having the imaging optical system 103.

A geometric transformation unit 110 performs distortion correction by a geometric transformation process (geometric deformation process) with respect to an acquired image. The geometric transformation unit 110 can also perform correction of lens aberration and correction of distortion that occur during rolling shutter readout. Furthermore, the geometric transformation unit 110 may correct image distortion of a subject caused by tilting or shaking of the image capturing apparatus 10 during a panning operation or a tilting operation. A detection signal indicating tilting or shaking of the image capturing apparatus 10 is acquired from a position and orientation change detection unit to be described below.

A reference pixel readout unit 111 calculates positions of reference pixels, which are required by the geometric transformation unit 110, and can rearrange pixels of readout results on the work memory 102. The reference pixel readout unit 111 can also perform coordinate conversion from an imaging plane to a recording screen in order to cut out an image region corresponding to a recorded angle of view during electronic image stabilization control.

In distortion correction performed by the geometric transformation unit 110, it is necessary to determine a corrected pixel position on a recording screen from a reference pixel based on an arbitrary functional relation. Therefore, after the reference pixel readout unit 111 reads out reference pixels, the geometric transformation unit 110 generates a pixel at a new pixel position from a plurality of reference pixels by, for example, bicubic interpolation. Although, in the present embodiment, an example is described in which the geometric transformation unit 110 and the reference pixel readout unit 111 are provided as separate modules, an embodiment in which a single module has the functions of these two modules is also possible.

In the present embodiment, auxiliary information is provided so that a user can recognize a state of intrusion of an out-of-imaging region (no-image region) into a recorded angle of view. In the present disclosure, incomplete information (incomplete information) is exemplified as auxiliary information that serves as a guide for changing electronic image stabilization strength. A user can select an appropriate electronic image stabilization strength (image blur correction strength) based on the presented incomplete information.

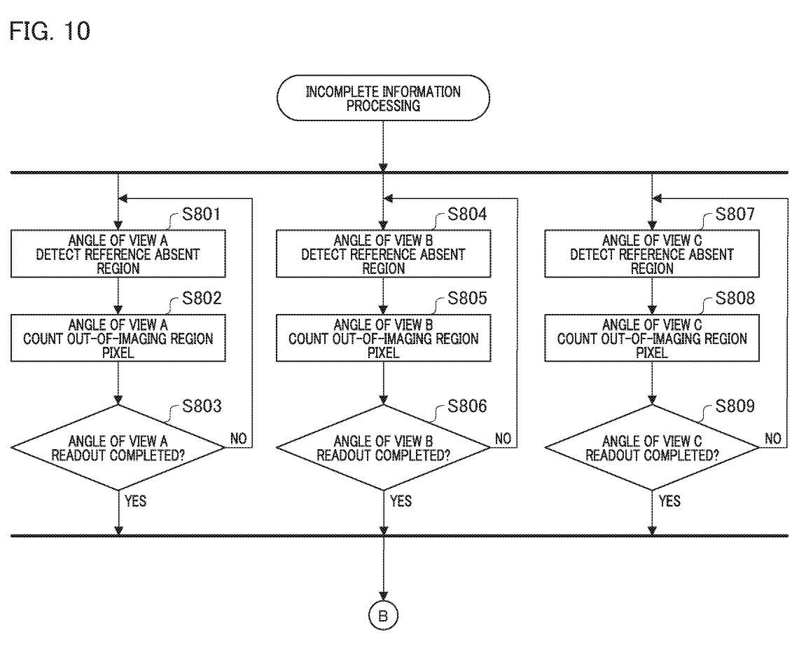

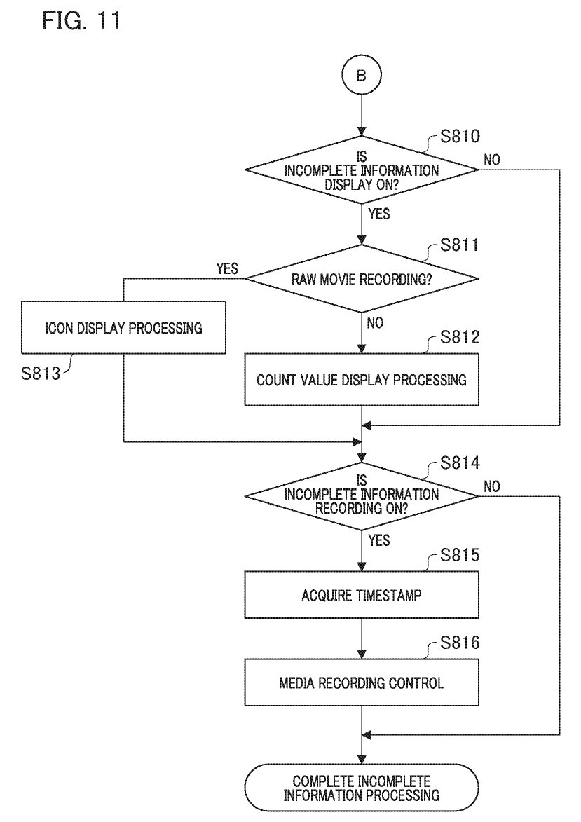

An incomplete information processing unit 112 is an information processing unit including a detection unit 1121 and an aggregation unit 1122. The detection unit 1121 performs processing for detecting a state of an out-of-imaging region that has intruded into a recorded angle of view. The aggregation unit 1122 performs aggregation processing on numerical information representing a state of an out-of-imaging region that has been detected by the detection unit 1121. Details of incomplete information processing will be described below with reference to FIG. 10 and FIG. 11. In the present embodiment, a reference pixel position that has been designated by the reference pixel readout unit 111 (or an address position in the work memory 102) serves as a detection signal source. Accordingly, in FIG. 1, a connection relation between these two elements is indicated by a status line with an arrow extending from the reference pixel readout unit 111 to the detection unit 1121.

A display control unit 113 performs control for display, by a display unit 114, of a result of processing performed by the development unit 106 and the like. The display control unit 113 may also perform control for managing an ON/OFF state of user notification information. The display unit 114 performs image display according to a control command from the display control unit 113. The display unit 114 includes display devices such as an electronic viewfinder (EVF) and a rear liquid crystal display. There is a method in which a control unit is independently configured for each display device, as well as a method in which a plurality of display devices is controlled by a single control unit that supervises display control.

A codec (CODEC) 115 performs encoding processing of image data for recording. A recording control unit 116 performs processing for writing data to a medium 117 in a desired file format. The medium 117 can record image information such as still images, moving images, and substitute images. The medium 117 can also record aggregation data (for example, hist data) related to incomplete information, as well as metadata that is added to the image information. The histogram data is data corresponding to a histogram to be described below.

An external IF unit 118 is a high-speed communication interface unit. For example, RAW moving-image data on which development or image processing has not been performed can be recorded in an external recording device (not illustrated) via the external IF unit 118. Alternatively, network connection with an external device such as a personal computer (PC) may be established via the external IF unit 118. An embodiment including a plurality of different external IF units is also possible.

A position and orientation change detection unit 119 detects a change in position and orientation of the image capturing apparatus 10 or of a lens unit including the imaging optical system 103. For example, the position and orientation change detection unit 119 includes an angular velocity meter (gyro sensor) and can acquire angular velocity information regarding an orientation change of the image capturing apparatus 10. The position and orientation change detection unit 119 also includes an accelerometer (acceleration sensor) and can acquire acceleration information regarding a position change of the image capturing apparatus 10. The position and orientation change detection unit 119 may also perform template matching between frames, using a Sum of Absolute Differences (SAD) and the like, based on an imaging image signal acquired by the image capturing device 104, to detect vibration applied to the image capturing apparatus 10. The position and orientation change detection unit 119 may detect vibration applied to the image capturing apparatus 10 by using at least one of the above methods, and a detection method for strength related to image stabilization is not particularly limited.

In FIG. 1, respective components (100 to 102, 106, 110 to 113, 115, 116, 118, and 119) configuring the image capturing apparatus 10 are connected to a bus and can transmit and receive necessary information to and from each other through a shared bus. It is to be noted that constituent elements such as an operation unit and a power supply unit, which are usually included in the image capturing apparatus 10, are omitted from illustration.

Next, electronic image stabilization (image blur correction) will be explained. The position and orientation change detection unit 119 detects vibration (such as vibration or shaking) that is applied to the image capturing apparatus 10 and outputs a detection signal to the CPU 100. In electronic image stabilization control, the CPU 100 performs, for example, processing for adjusting, for each frame, a cut-out position of a recording screen on the imaging plane so as to cancel shaking of the image capturing apparatus 10. At that time, in a case in which an entire cut-out region of the recording screen falls within the imaging plane, no problem arises.

In a case in which the strength of electronic image stabilization is increased, the recorded angle of view is set to be narrower so that a margin can be secured even in a case in which movement of a cut-out region within the imaging plane is large. On the other hand, in a case in which the strength of electronic image stabilization is weakened or is not made effective, a margin is minimally required or unnecessary, and therefore the recorded angle of view can be set to be wider.

Cut-out processing of a recording screen in electronic image stabilization control is coordinate conversion processing in which a part of the recording screen from the imaging plane is cut out to form a new rectangular region. As described above, this processing can be included in a series of processing that is executed by the geometric transformation unit 110 and the reference pixel readout unit 111. In the geometric transformation processing, correction of rolling shutter distortion, correction of lens aberration, and correction of distortion caused by tilt of the apparatus due to a panning operation, a tilting operation, and the like are performed. In distortion correction, processing is performed to reconstruct pixels of a recorded image by reading out reference pixels from pixel positions before correction (interpolation processing is performed if necessary). In a case in which a reference pixel is absent (no reference destination) during the processing, an out-of-imaging region is included in the recording screen. With respect to such an out-of-imaging region within a cut-out region, processing is performed for determining whether or not the region has been an imaging range in preceding and succeeding frames and whether or not the region can be generated by another interpolation method, and incomplete information processing to be described below is performed according to a determination result.

Even if movement of the cut-out region for electronic image stabilization is not taken into consideration, the shape of a margin region changes before and after distortion correction. For example, depending on the result of rolling shutter distortion correction, the margin may become narrower. In the present embodiment, with respect to an out-of-imaging region that occurs within a range of a cut-out region for electronic image stabilization, detection is performed regardless of the cause of generation (including a factor other than adjustment of a cut-out position).

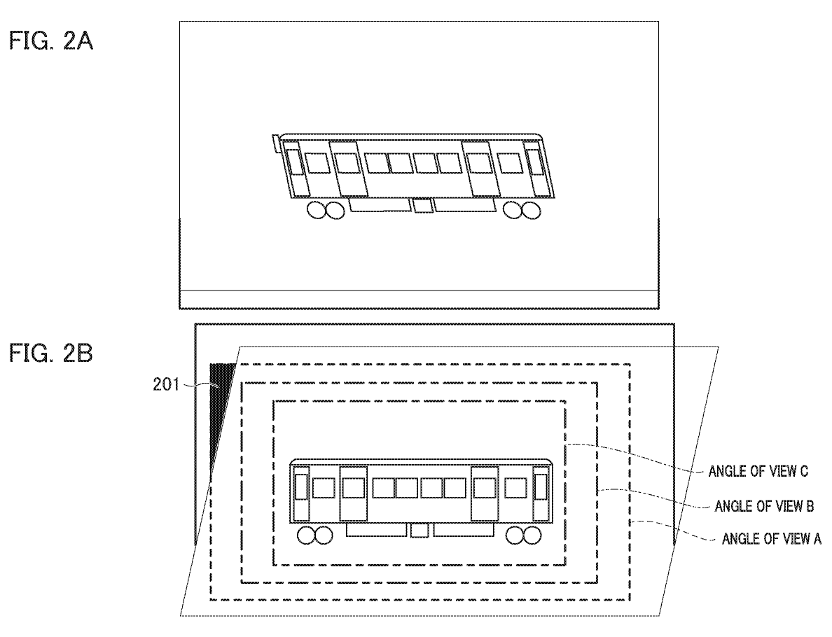

With reference to FIG. 2A and FIG. 2B, taking rolling-shutter distortion correction as a representative factor other than adjustment of the cut-out position, the relation between electronic image stabilization strength and the recorded angle of view will be explained. FIG. 2A is a schematic diagram illustrating an example of an image that is an imaging result before rolling shutter distortion correction. The image capturing device 104 performs rolling shutter scanning, and an example is shown in which rolling shutter distortion occurs in an oblique direction during pixel readout of a moving member (subject). FIG. 2B is a schematic diagram illustrating a processing example in which the geometric transformation unit 110 corrects image distortion corresponding to the moving member. Although image distortion of the moving member is corrected, the frame shape (rectangular shape) in FIG. 2A is deformed into a parallelogram shape, as illustrated in FIG. 2B. In this state, in a case in which angle of view A, angle of view B, and angle of view C, which correspond to the three levels of electronic vibration reduction strength, are set, in the angle of view A in FIG. 2B (inside the rectangular frame that is indicated by a broken line), an out-of-imaging region 201 that is indicated by a black triangular portion appears. In contrast, in the angle of view B (inside the rectangular frame that is indicated by a chain double-dashed line) and in the angle of view C (inside the rectangular frame that is indicated by a single-dashed dotted line), in a case in which the electronic image stabilization strength is further increased, no out-of-imaging region appears.

The state schematically illustrated in FIG. 2B is merely an example, and in a case in which only a moving object portion that is an actual processing target is geometrically transformed, the shape of the entire frame is not significantly deformed. However, in practice, since correction of distortion caused by a lens and correction of subject distortion caused by tilt of the image capturing apparatus are additionally performed in this state, the frame shape in FIG. 2B is further deformed and may become more distorted. In electronic image stabilization, from this state, processing is performed to further move a cut-out frame in accordance with shaking of the image capturing apparatus 10 so as to cancel the shaking. Therefore, in a state in which the out-of-imaging region 201 is already included within an angle of view, as illustrated for the angle of view A in FIG. 2B, the margin becomes insufficient. In a case in which the position of the cut-out region changes due to shaking of the image capturing apparatus 10 and the like, and the region moves, the state of the out-of-imaging region 201 also changes. It is to be noted that a margin shortage resulting from movement (change) of a cut-out region of an image can also occur in imaging using an imaging element of a global shutter type.

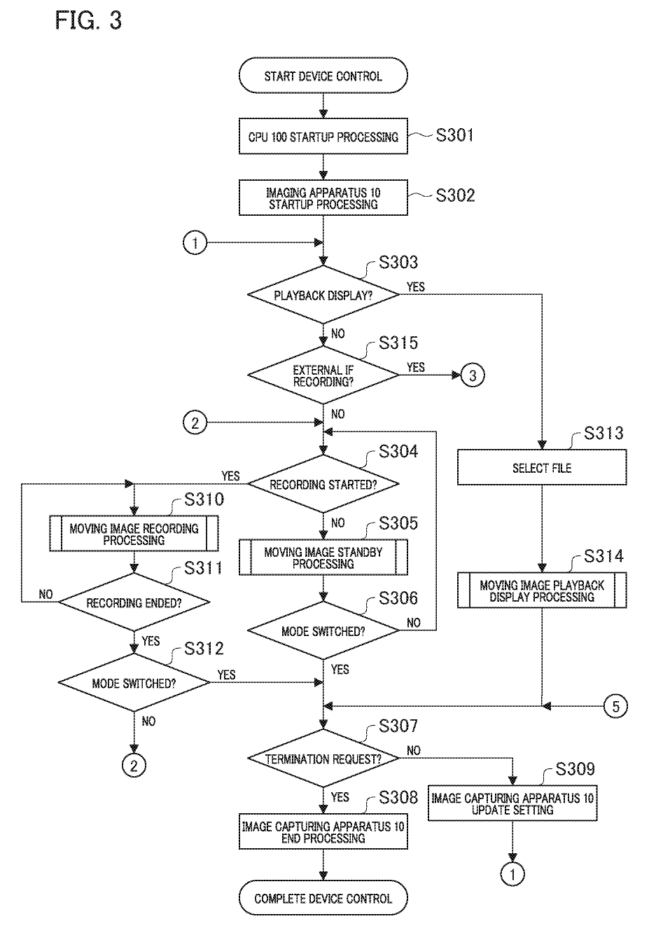

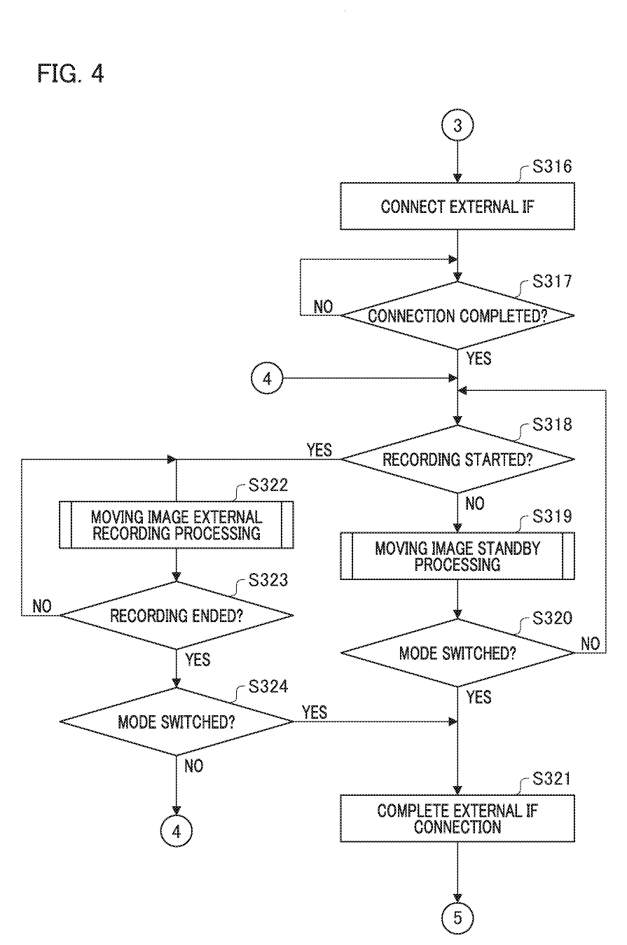

Next, overall control of the image capturing apparatus 10 will be explained with reference to FIG. 3 and FIG. 4. FIG. 3 is a flowchart illustrating a part of the processing, and FIG. 4 is a flowchart illustrating another part of the processing. The processing starts when the CPU 100 starts after power having been supplied thereto.

In step S301 of FIG. 3, start-up processing for the CPU 100 is executed. The CPU 100 reads out a control program from the nonvolatile memory 101 and executes start-up processing (clock setting, port setting, reset processing, and the like) according to the control program. Next, in step S302, start-up processing for the main body of the image capturing apparatus 10 is executed. Start-up processing for devices connected to the CPU 100 (including a start-up check of the work memory 102, register settings of each hardware module, and the like) is executed according to an instruction from the CPU 100. Then, the process proceeds to step S303.

In step S303, the CPU 100 determines whether or not the setting state of the image capturing apparatus 10 is a playback display mode. In a case in which it is determined to be the playback display mode, the process proceeds to step S313, and in a case in which it is determined not to be the playback display mode, the process proceeds to step S315. Examples of control modes of the image capturing apparatus 10 are as follows.

A mode in which moving-image recording to the medium 117 is performed, and a standby state mode before the recording.

A mode in which moving-image recording is performed via the external IF unit 118, and a standby state mode before the recording.

A playback display mode.

A still image shooting mode.

A live view (video) display mode before shooting.

In moving-image recording via the external IF unit 118, when a moving image is recorded in a predetermined format, processing for high-speed data transfer to an external recording device is performed. The moving image of a predetermined format refers to a moving image such as a RAW moving image or a moving image obtained by performing only image sensor correction and encoding the image with application of log gamma (hereinafter referred to as a “RAW moving image and the like”).

In step S315, the CPU 100 determines whether or not a moving-image recording mode via the external IF unit 118 has been set. In a case in which it is determined to be this mode, the process proceeds to step S316 in FIG. 4, and in a case in which it is determined not to be this mode, the process proceeds to step S304. In step S304, the CPU 100 determines whether or not an operation for issuing a start instruction for moving-image recording has been performed by a photographer. The presence or absence of a start instruction for moving-image recording can be determined based on whether or not a predetermined operation member (for example, a REC button) has been pressed down. In a case in which it is determined that the operation for issuing the start instruction for moving-image recording has been performed, the process proceeds to step S310, and in a case in which it is determined that this operation has not been performed, the process proceeds to step S305.

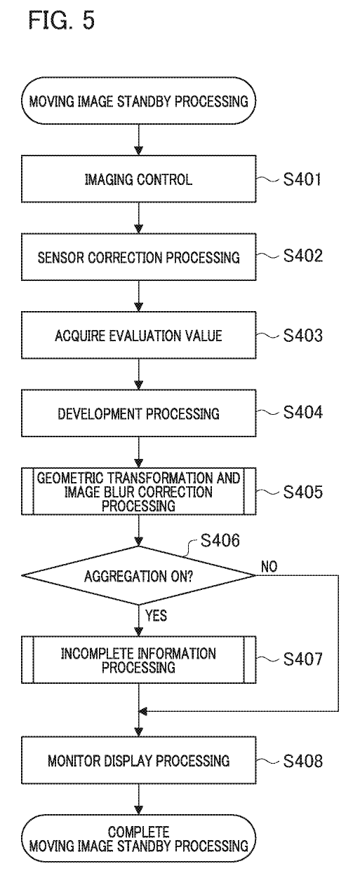

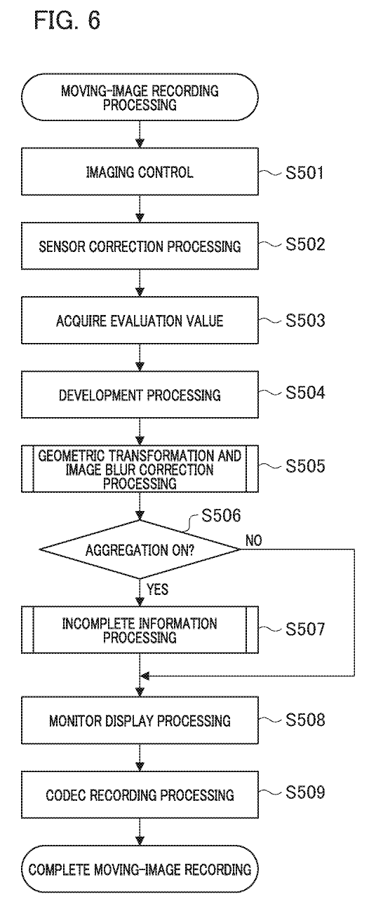

In step S305, the CPU 100 executes moving image standby processing. The moving image standby processing will be described below with reference to FIG. 5. After step S305, the process proceeds to step S306. In step S310, the CPU 100 executes moving-image recording processing. The moving-image recording processing will be described below with reference to FIG. 6. After step S310, the process proceeds to step S311.

In step S306, the CPU 100 confirms a mode switching state of the image capturing apparatus 10. In this case, the CPU 100 performs confirmation of switching to the playback display mode and of a request for termination processing of the image capturing apparatus 10. In a case in which the CPU 100 determines that there is no mode switching request, the CPU 100 maintains a state of waiting for the REC button to be pressed, and then the process proceeds to step S304. Additionally, in a case in which the CPU 100 determines that a mode switching request has occurred, the process proceeds to step S307.

In step S307, the CPU 100 confirms a termination request. The CPU 100 determines whether or not the image capturing apparatus 10 will perform power off processing. Power off can be determined when operation of a power switch (not illustrated) is performed, or when it is detected by a timer (not illustrated) that a recording standby state has continued for a predetermined period or longer. Additionally, in a case in which it is detected that a battery remaining amount has become equal to or less than a threshold, it is also possible to make a power off determination. In a case in which it is determined that a termination request has occurred, the process proceeds to step S308, and in a case in which it is determined that no termination request has occurred, the process proceeds to step S309.

In step S308, the CPU 100 executes termination processing of the image capturing apparatus 10. The CPU 100 stops power supply to the image capturing device 104, the display unit 114, the recording control unit 116, the external IF unit 118, and the like. The CPU 100 may also perform processing for storing information indicating a current control state of the image capturing apparatus 10 in the nonvolatile memory 101. After the processing of step S308, the series of processing is terminated. In step S309, the CPU 100 executes setting update processing of the image capturing apparatus 10. To realize power saving when control modes are switched, the CPU 100 can temporarily stop scanning of the image capturing device 104 and stop power supply to the image capturing device 104. The CPU 100 may also perform display control of a menu (not illustrated) that is displayed on a screen of the display unit 114. Upon completion of the processing of step S309, the process transitions to step S303.

In step S311 of FIG. 3, the CPU 100 determines whether or not the moving-image recording processing in S310 has been terminated. In a case in which it is determined that the moving-image recording processing has been terminated, the process proceeds to step S312. In a case in which it is determined that the moving-image recording processing is continuing, the process returns to step S310, and the moving-image recording processing is continued. It is to be noted that determination processing of the termination of moving-image recording is executed based on various conditions such as a user operation of the REC button (recording termination instruction), a medium remaining amount, a battery remaining amount, and a temperature inside of the image capturing apparatus 10.

In step S312, the CPU 100 confirms a mode switching state of the image capturing apparatus 10. For example, determination is performed as to whether or not switching to the playback display mode is to be performed and whether or not termination processing of the image capturing apparatus 10 is to be performed. In a case in which it is determined that there is no change in the mode, the CPU 100 maintains a state of waiting for the REC button to be pressed, and the process transitions to step S304. Additionally, in a case in which the CPU 100 determines that a mode switching request has occurred, the process proceeds to step S307.

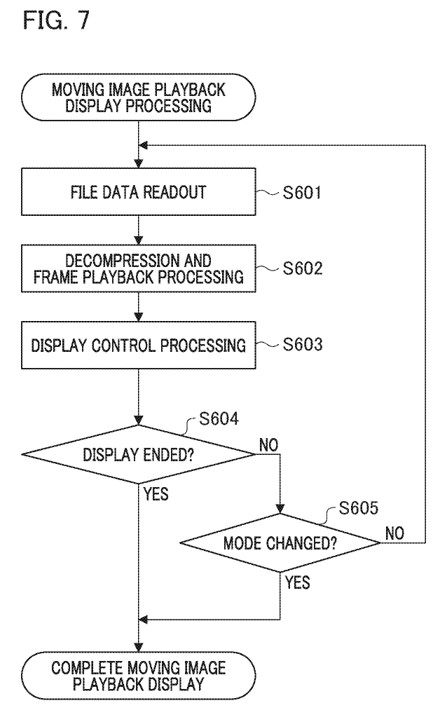

In step S313 of FIG. 3, the CPU 100 performs file selection processing in the playback display mode. For example, the CPU 100 performs control to display thumbnail images on a display screen of a rear liquid crystal display (not illustrated) that is provided in the image capturing apparatus 10, and performs file selection corresponding to a thumbnail image according to a user operation instruction. Next, in the moving image playback display processing of step S314, display is performed on the rear liquid crystal display. The moving image playback display processing in step S314 will be described below with reference to FIG. 7. After step S314, the process transitions to step S307.

The processing of steps S316 to S324 that is illustrated in FIG. 4 is processing for recording RAW moving images and the like to an external recording device (not illustrated) via the external IF unit 118. In step S316, the CPU 100 executes connection processing with the external recording device via the external IF unit 118. Next, in step S317, the CPU 100 determines whether or not connection with the external recording device has been completed. In a case in which it is determined that the connection has been completed, the process proceeds to step S318. In a case in which the CPU 100 determines that the connection has not been completed, the CPU 100 repeatedly executes the processing of step S317 in a standby state waiting for recording to start. During a period until it is determined in step S317 that the connection has been completed, loop processing is performed. Additionally, a timer routine (not illustrated) is started by the CPU 100, and in a case in which a timeout occurs, exception processing is executed, and processing for restarting the image capturing apparatus 10 from an initial state may be performed. The processing of steps S318 to S320 that are illustrated in FIG. 4 is respectively the same as the processing of steps S304 to S306 in FIG. 3, and therefore explanation thereof will be omitted.

In a case in which the process proceeds from step S320 to step S321 in FIG. 4, the CPU 100 executes connection completion processing (normal completion processing) of the external IF unit 118. It is to be noted that the connection completion processing itself may be executed as a separate subroutine, and just confirmation of a completion flag may be performed in step S321. After the processing of step S321, the process transitions to step S307 of FIG. 3.

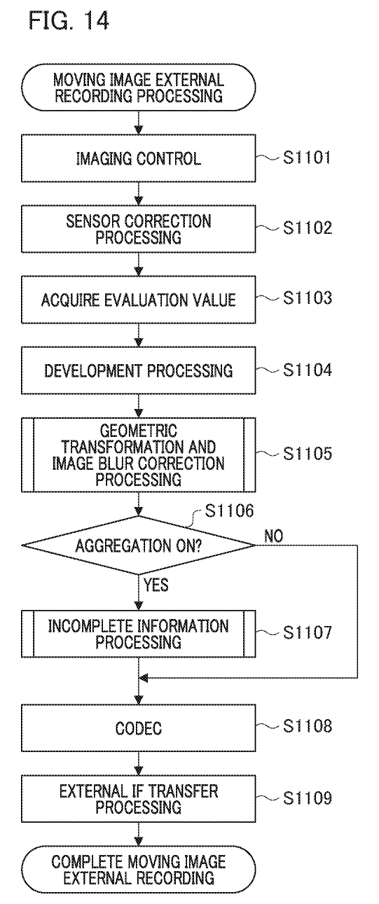

On the other hand, in a case in which, in step S318 of FIG. 4, the CPU 100 determines that recording to the external recording device has been started, the process proceeds to step S322. In step S322, the CPU 100 executes moving image external recording processing. The moving image external recording processing will be described below with reference to FIG. 14. Next, in step S323, the CPU 100 determines whether or not the moving-image external recording processing has been terminated. In a case in which it is determined that the moving image external recording processing has been terminated, the process proceeds to step S324, and in a case in which it is determined that the processing has not been terminated, the process returns to step S322 to continue the moving image external recording processing.

In step S324, the CPU 100 performs mode switching determination processing for the image capturing apparatus 10. In a case in which the determination result is affirmative (that is, a mode switching request has occurred), the process proceeds to step S321, and in a case in which the determination result is negative (that is, no mode switching request has occurred), the process returns to step S318.

With reference to FIG. 5, the moving image standby processing of step S305 in FIG. 3 and step S319 in FIG. 4 will be explained. In a standby state of moving-image recording, although file recording to a medium and the like is not actually performed, processing is executed so as to display, on the display unit 114, captured images at a predetermined frame rate. In step S401, the CPU 100 performs imaging control. During moving image standby, imaging processing for monitor display on the display unit 114 is performed. Switching of a frame rate and the number of pixels to be acquired may be performed. In a case of a paused state relative to a REC state, driving of the image capturing device 104 may be performed in the same manner as during moving-image recording. In a case in which the standby state continues for a predetermined period or longer, live-view display control in a power saving mode may be performed by lowering the frame rate. Next, the process proceeds to step S402.

In step S402, the imaging correction unit 105 performs correction processing on the acquired imaging data for correction caused by the image sensor. Here, defective pixel correction, shading correction, and the like are performed. Next, in step S403, the CPU 100 acquires evaluation values for AE (auto exposure) processing and automatic white balance (AWB) processing based on an output of the photometry unit 107 and acquires an evaluation value for AF processing based on an output of the distance measuring unit 108. For example, in AF processing, the CPU 100 performs control of the imaging optical system 103 to an in-focus state via the optical system control unit 109 by using the acquired evaluation values. Acquisition processing of each evaluation value may be executed in parallel.

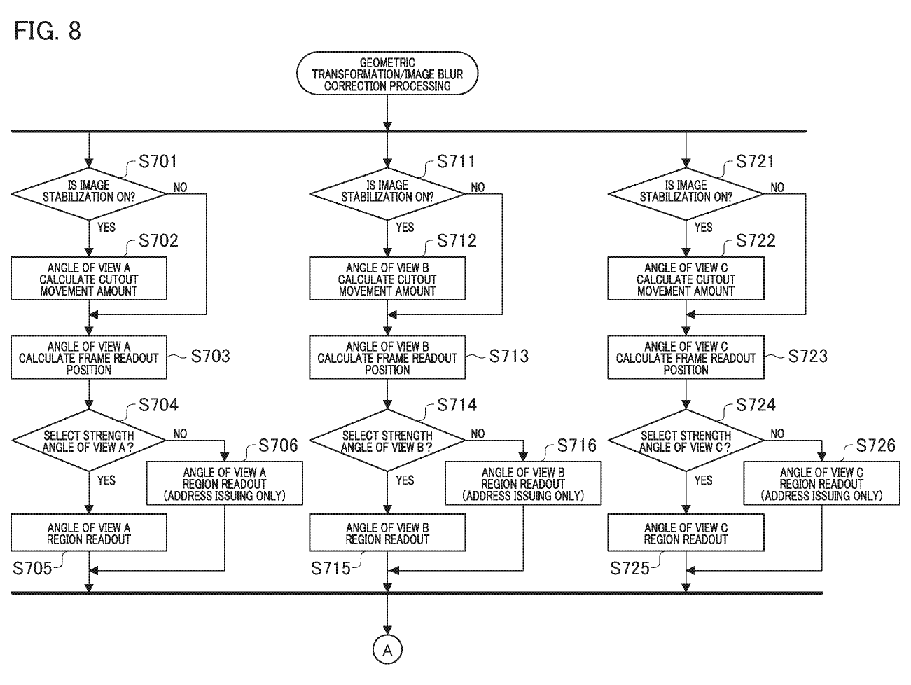

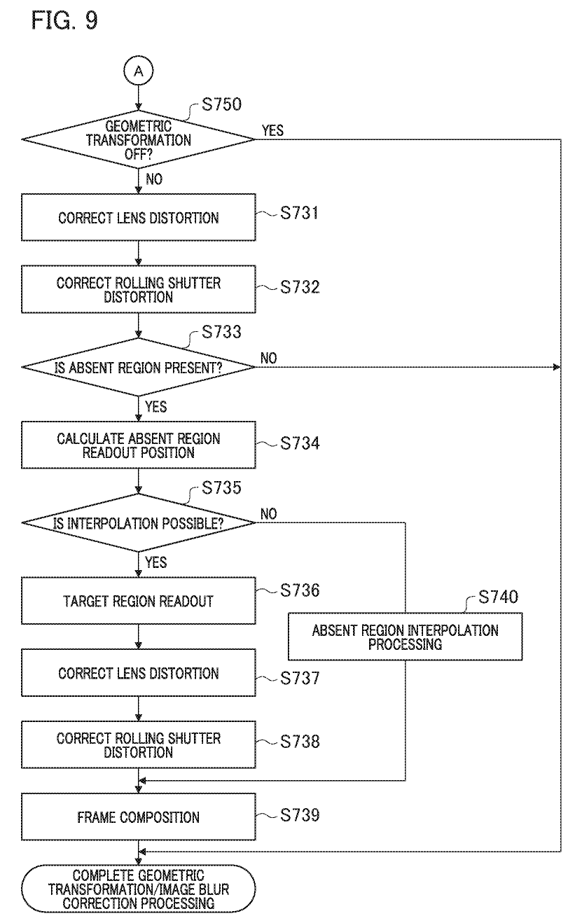

Next, in step S404, the CPU 100 causes the development unit 106 to execute development processing, and subsequently, in step S405, the CPU 100 executes geometric transformation processing and image blur correction processing. Details of the processing in step S405 will be described below with reference to FIG. 8 and FIG. 9. Next, in step S406, the CPU 100 performs ON/OFF determination regarding aggregation related to an out-of-imaging region within a cut-out angle of view in electronic image stabilization control. The ON/OFF state of the aggregation related to the out-of-imaging region can be selected on a menu screen (not illustrated) according to a user operation instruction. In a case in which it is determined that aggregation is to be performed (ON determination), the process proceeds to step S407, and in a case in which it is determined that aggregation is not to be performed (OFF determination), the process proceeds to step S408.

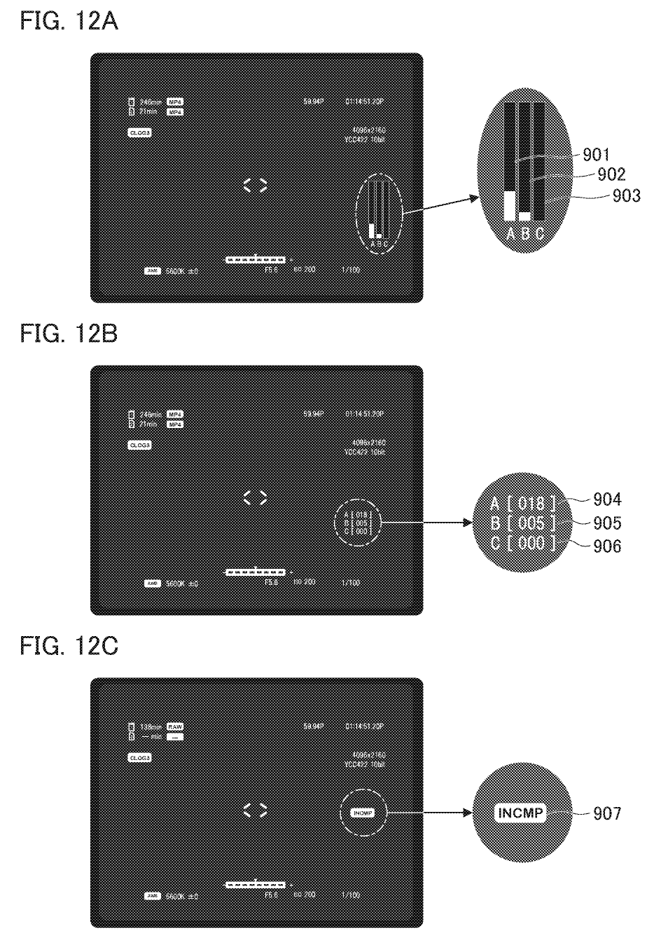

In step S407, the CPU 100 executes incomplete information processing. Details of the process will be described below with reference to FIG. 10 and FIG. 11. Next, in step S408, the CPU 100 performs monitor display processing. In a case in which the ON determination regarding aggregation related to incomplete information has been performed, the CPU 100 performs control to superimpose a result of the incomplete information processing in step S407 on a captured image and display it on a screen of the display unit 114. Examples of notifying a user by using a monitor display will be described below with reference to FIG. 12A to FIG. 12C.

After completion of the processing of step S408, the moving image standby processing is completed. The processing that is illustrated in FIG. 5 is not limited to flow control in which a next processing proceeds after waiting for termination of each processing. Flow control such as catch-up processing, in which subsequent processing is started without waiting for completion of preceding processing, may be employed. Although latency (processing delay) occurs, processing such as parallel processing can be performed. The moving image standby processing illustrated in FIG. 5 is repeatedly executed at a predetermined frame rate.

With reference to FIG. 6, step S310 (moving-image recording processing) in FIG. 3 will be described. In step S501, the CPU 100 performs imaging control for moving-image recording. The imaging control in step S401 (FIG. 5) and that in this step may differ in frame rate and in the number of readout pixels. Next, in step S502, the imaging correction unit 105 performs image sensor correction processing on imaging data for moving-image recording, similarly to step S402 of FIG. 5. Then, in step S503, the CPU 100 performs acquisition processing of evaluation values, similar to step S403 of FIG. 5. The evaluation values (such as gain adjustment values for white balance) that are acquired here may be reflected in development processing that is performed by the development unit 106. Next, the process proceeds to step S504.

In step S504, the CPU 100 causes the development unit 106 to execute development processing, and then the process proceeds to step S505. The processing of steps S505 to S507 is the same as the processing of steps S405 to S407 in FIG. 5, and therefore an explanation thereof will be omitted. After completion of step S507, the process proceeds to step S508.

In step S508, the CPU 100 performs monitor display processing. Here, resizing processing is executed so that the number of pixels of an image obtained as a result of development processing matches the number of display pixels of the display unit 114. Next, in step S509, codec processing and recording processing to the medium 117 are executed. The codec processing can be executed by a known method, and therefore a detailed explanation thereof will be omitted. There is a case in which a proxy moving image is recorded as a sample moving image for editing during moving-image recording. For example, processing may be performed in which a proxy moving image in which the data amount is reduced by resize processing is recorded together with the main moving image. After completion of the processing of step S509, the moving-image recording process is completed.

With reference to FIG. 7, step S314 (the moving image playback display processing) in FIG. 3 will be explained. In step S601, the CPU 100 performs the processing of reading out moving image file data up to an arbitrary break. The moving image file may be compressed by the codec 115. In the readout processing of the moving image file, a certain amount of data may be temporarily expanded from the medium 117 into the work memory 102. Next, in step S602, the CPU 100 causes the codec 115 to decompress the read compressed data and perform processing for reproducing frame data. The reproduced frame data may be temporarily stored in the work memory 102. Next, the process proceeds to step S603.

In step S603, the CPU 100 performs the processing of displaying the frame data that was decompressed in step S602 on a screen of the display unit 114 via the display control unit 113. Next, in step S604, the CPU 100 performs display termination determination. The termination determination for the playback display is performed based on a user operation instruction, file completion, a battery remaining amount, and the like. Note that the termination processing itself may be executed by a separate handler, and just confirmation of a flag may be performed in step S604. In a case in which it is determined that the playback displayed will be terminated, the moving image playback display processing is completed, and in a case in which it is determined that playback display will not be terminated, the process proceeds to step S605.

In step S605, the CPU 100 confirms a mode switching state of the image capturing apparatus 10. In a case in which it is determined that a switching request to another mode has occurred during moving image playback display, the moving image playback display processing is terminated. In a case in which continuation of the moving image playback display processing is determined, the process returns to step S601 to continue the processing. It is to be noted that playback display of a moving image file is continuous playback processing, and therefore catch-up processing may be performed without waiting for completion of each processing.

Next, geometric transformation and image blur correction processing (FIG. 5: step S405, FIG. 6: step S505) will be explained with reference to FIG. 8 and FIG. 9. In the image capturing apparatus 10 of the present embodiment, electronic image stabilization and geometric transformation are closely related, and a processing flow thereof is exemplified. In FIG. 8, a range indicated between two bold lines indicates that the processing within the range is parallel processing. The following three systems of processing are executed in parallel.

Steps S701 to S706: Reference pixel readout control for geometric transformation with respect to the angle of view A.

Steps S711 to S716: Reference pixel readout control for geometric transformation with respect to the angle of view B.

Steps S721 to S726: Reference pixel readout control for geometric transformation with respect to the angle of view C.

Since each type of processing for the three systems is similar except for the differences in the angle of view, the processing of steps S701 to S706 will be explained. It is to be noted that the determination processing of steps S701, S711, and S721 is ON/OFF state determination processing regarding the setting of electronic image stabilization control, and the CPU 100 performs the determination based on a user operation instruction, a control state of the image capturing apparatus 10, and the like.

In step S701, the CPU 100 determines whether the electronic image stabilization control is set to ON. In a case in which it is determined that the electronic stabilization control has been set to ON, the process proceeds to step S702, and in a case in which it is determined that this has been set to OFF, the process proceeds to step S703.

In step S702, the CPU 100 calculates a cut-out movement amount for the recording screen for electronic image stabilization control. Although conversion processing into an address value is performed in the work memory 102, it is also possible to acquire a movement amount of the image capturing apparatus 10 from a detection signal that is output by an acceleration sensor. Next, in step S703, the CPU 100 calculates a frame readout position for the angle of view A. The frame readout position refers to positions of distributed reference pixels that are to be read out so as to form a rectangular region after lens distortion correction and rolling shutter distortion correction. Distortion caused by a lens or by the imaging sensor readout can be formulated in advance. In contrast, in a case in which distortion of an image is to be corrected when the distortion has been caused by tilting of the image capturing apparatus 10 due to a panning operation or a tilting operation, it is necessary to acquire a detection signal that is output by a gyro sensor and to perform a calculation each time using the CPU 100. Next, the process proceeds to step S704.

In step S704, the CPU 100 confirms a currently selected electronic image stabilization strength. In a case in which an angle of view (recorded angle of view) corresponding to a recording screen is set to the angle of view A, a strength selection corresponding to the angle of view A is performed. In this case, the process proceeds to step S705. Additionally, in a case in which it is determined in step S704 that the setting is not for the angle of view A, the process proceeds to step S706.

In step S705, the CPU 100 performs the processing of reading out reference pixels from the work memory 102. This readout of reference pixels is performed for a region corresponding to the angle of view A. Additionally, in step S706, the CPU 100 performs only address issuance to the work memory 102. For example, it is assumed that the electronic image stabilization strength for display is set for a region of the angle of view B. In this case, only the address issuance in step S706 is performed.

With respect to the processing of steps S711 to S716 in FIG. 8, the above-described explanation may be appropriately read by replacing “the angle of view A” with “the angle of view B.” For example, in a case in which the electronic image stabilization strength at the angle of view B is selected, the process proceeds from step S714 to step S715, and the readout of reference pixels is actually performed for a region corresponding to the angle of view B. It is to be noted that reference pixels for a region corresponding to the angle of view B may be temporarily stored in another region within the work memory 102 that is separate from a region in which the imaging plane is expanded.

With respect to the processing of steps S721 to S726 in FIG. 8, the above described explanation may be appropriately read by replacing “the angle of view A” with “the angle of view C.” For example, in a case in which the electronic image stabilization strength at the angle of view C is being selected, the process proceeds from step S724 to step S726.

Additionally, for example, during recording of RAW moving images and the like, the condition determination results in steps S704, S714, and S724 of FIG. 8 are all negative determination results (“NO” in the drawing), and the processing of steps S706, S716, and S726 is executed respectively in correspondence therewith.

After the processing of FIG. 8, the process proceeds to step S750 in FIG. 9. In step S750, the CPU 100 confirms whether geometric transformation processing is set to ON or OFF. For example, when recording RAW moving images and the like, geometric transformation processing may be set to OFF, and an external apparatus such as a personal computer (PC) may perform the processing during editing. In a case in which geometric transformation processing is set to OFF, the geometric transformation and image blur correction processing is completed. In a case in which geometric transformation processing is set to ON, the process proceeds to step S731. In a case in which geometric transformation processing is set to OFF, the process transitions from step S714 to step S716 in FIG. 8, and readout of reference pixels in step S715 becomes unnecessary. In the present embodiment, the processing of steps S731 to S740 in FIG. 9 will be explained as an example of processing for a recording screen corresponding to the angle of view B.

In step S731, the CPU 100 performs lens distortion correction. Correction information for the lens can be acquired from the imaging optical system 103 (lens unit). Pixels after lens distortion correction can be obtained, for example, by performing correction calculations using reference pixels at a plurality of points (for example, four points) that have been read out in a mesh pattern. Since lens distortion correction is not a feature of the present disclosure, a detailed explanation thereof will be omitted. Next, the process proceeds to step S732.

In step S732, the CPU 100 performs rolling shutter distortion correction (FIG. 2A and FIG. 2B). Since this distortion correction is based on a readout method (rolling shutter method) of the imaging sensor, in a case in which no moving object is present as a subject, the correction may be omitted. After completion of the distortion corrections in steps S731 and S732, a recorded image corresponding to the angle of view B can be obtained. Next, the process proceeds to step S733.

In step S733, the CPU 100 confirms the presence or absence of an out-of-imaging region within a recording screen corresponding to the angle of view B. A region in which no reference pixel is present is hereinafter referred to as an “absent region.” In the present disclosure, an out-of-imaging region (no-image region) and an absent region are distinguished in notation. As will be described below, there is a case in which an absent region can be interpolated. Determination of the presence or absence of an absent region can be performed based on a detection result of access to an area outside of the reference-pixel region in the work memory 102, and therefore may be included in the processing of step S715 in FIG. 8. Additionally, in the work memory 102, both an address of the reference pixel region (readout side) that was detected upon detection of an absent region and an address of the recording screen (storage side) (used when storing a generated pixel) may be temporarily stored together. In the determination processing of step S733, it is sufficient to use only the detection result of the presence or absence of an absent region. In a case in which it is determined in step S733 that an absent region is present, the process proceeds to step S734, whereas in a case in which it is determined that no absent region is present, the series of processing is terminated.

In step S734, the CPU 100 determines whether or not pixel information for the out-of-imaging region of the current frame can be acquired from the immediately preceding frame, and performs calculation of a readout position for the absent region. At this time, it is not necessary to perform calculation for all pixels within the frame. It is sufficient to perform recalculation only for a portion that is related to the out-of-imaging region of the immediately preceding frame. However, since positioning between the image of the immediately preceding frame and the image of the current frame is required, a known method may be applied, and a detailed explanation thereof will be omitted. Next, the process proceeds to step S735.

In step S735, the CPU 100 determines whether or not first interpolation processing using the immediately preceding frame is possible. In a case in which it is determined that the first interpolation processing is possible, the process proceeds to step S736, whereas in a case in which it is determined that the first interpolation processing is not possible, the process proceeds to step S740.

In step S736, the CPU 100 performs the processing of reading out pixel information for a target region from the work memory 102. Subsequently, in step S737, lens distortion correction is performed, and in step S738, rolling shutter distortion correction is further performed. Since the processing of steps S737 and S738 is the same as that of steps S731 and S732, respectively, detailed explanation thereof will be omitted. Next, in step S739, the CPU 100 executes frame synthesis processing. This processing is the processing of synthesizing pixels of a recorded image of the current frame with pixels that are interpolated for the out-of-imaging region. To prevent unnaturalness at boundaries between regions, adjustment processing may be performed by using digital gains for each color, matrix operations, and the like. After the processing in step S739, the geometric transformation and image blur correction processing is completed.

In step S740, the CPU 100 performs second interpolation processing (interpolation processing of an absent region). The CPU 100 performs interpolation processing for shortage pixels that cannot be compensated for by in-frame interpolation or extrapolation (such as referencing a preceding frame). In pixel interpolation without a reference portion (reference pixels), the second interpolation processing can be performed by a configuration that includes a calculating unit that performs the generation of pixels using, for example, generative AI (not illustrated). Additionally, by using an external collaboration IF unit (not illustrated), the second interpolation processing can be performed in collaboration with external cloud processing according to a predetermined image generation algorithm. For example, there is an image generation algorithm such as a Deep Convolutional Generative Adversarial Network (DCGAN). With respect to calculation delay in the interpolation processing of an absent region, the processing by the codec 115 may be executed after the delay has been absorbed by the work memory 102. In a case of recording RAW moving images and the like, the image capturing apparatus 10 need not forcibly perform the interpolation processing in step S740. It is sufficient to utilize, on an editing-side apparatus (such as a PC), functions (resources) of advanced generative AI. After completion of step S740, the process transitions to step S739.

In the present embodiment, with respect to the first interpolation processing, interpolation by extrapolation (interpolation using reference pixels) is assumed in steps S736 to S738 of FIG. 9. The first interpolation processing and the second interpolation processing in step S740 (for example, processing utilizing the above-described generative AI) may be integrated. It is to be noted that the interpolation method is not limited.

With reference to FIG. 10 and FIG. 11, incomplete information processing (step S407 of FIG. 5 and step S507 of FIG. 6) will be explained. Processing is performed to aggregate frequencies of out-of-imaging regions accounted for in each of the angle of view A, the angle of view B, and the angle of view C. In FIG. 10, a range indicated between two bold lines indicates that the processing within the range is parallel processing. The following three systems of processing are executed in parallel.

S801 to S803: Processing regarding a region corresponding to the angle of view A.

S804 to S806: Processing regarding a region corresponding to the angle of view B.

S807 to S809: Processing regarding a region corresponding to the angle of view C.

Since each of the three systems is similar except for differences in the angle of view, the processing of steps S801 to S803 will be explained. The following processing is executed by the incomplete information processing unit 112 according to a control command from the CPU 100.

In step S801, during the pixel readout of a region corresponding to the angle of view A in step S705 or S706 of FIG. 8, processing for detecting access to an absent region in which reference pixels at the angle of view A are not present is executed according to an instruction from the CPU 100. Regarding determination of the presence or absence of reference pixels, in a case in which an address issued to the work memory 102 during the readout of reference pixels in the region corresponding to the angle of view A is accessing a region outside of the original storage region (that is, an out-of-imaging region of a reference image), it can be determined that the reference pixels are absent. In the present embodiment, detection of an absent region in which reference pixels are not present by the detection unit 1121 is referred to as “detection.” For example, by inserting a decoder into the detection unit 1121 with an arbitrary region of the work memory 102 as a target, access to a region outside of the storage region (that is, an out-of-imaging region of a reference image) can be detected. Next, the process proceeds to step S802. In step S802, the aggregation unit 1122 acquires the detection result that was obtained in step S801 and counts the number of accesses (corresponding to the number of pixels) to an out-of-imaging region. Next, in step S803, determination processing is performed as to whether or not the readout of reference pixels in the region corresponding to the angle of view A has been completed. In a case in which completion of the processing of step S705 (or step S706) in FIG. 8 is confirmed and it is determined that the readout of reference pixels in the region corresponding to the angle of view A has been completed, the process transitions to step S810 of FIG. 11. In a case in which it is determined that the readout of reference pixels in the region has not been completed, the process returns to step S801 to continue the processing.

In the series of processing illustrated in steps S801 to S803, detection of an absent region (step S801) may be linked to the processing of step S705 (or step S706) of FIG. 8. Since hardware resources (such as address lines of the work memory 102) serving as detection targets of access are shared by the processing of steps S705 and S706, selection of either one of step S705 or step S706 in FIG. 8 has no influence.

With respect to the processing of steps S804 to S806 in FIG. 10, the explanation described above may be appropriately read by replacing “the angle of view A” with “the angle of view B.” Detection of an absent region (step S804) regarding the angle of view B may be linked to the processing of step S715 (or step S716) of FIG. 8. Additionally, with respect to the processing of steps S807 to S809 in FIG. 10, the explanation described above may be appropriately read by replacing “the angle of view A” with “the angle of view C.” Detection of an absent region (step S807) regarding the angle of view C may be linked to the processing of step S725 (or step S726) of FIG. 8. After steps S803, S806, and S809, the process proceeds to step S810 of FIG. 11.

In step S810 of FIG. 11, the incomplete information processing unit 112 determines whether or not the display setting for incomplete information is set to ON. In a case in which the setting is ON, processing for notifying the user of incomplete information is performed. In a case in which it is determined during step S810 that this setting is ON, the process proceeds to step S811, and in a case in which it is determined that this setting is OFF, the process proceeds to step S814.

In step S811, the incomplete information processing unit 112 confirms a current recording format and determines whether or not recording of RAW moving images and the like is being performed. In a case in which it is determined that the current recording format corresponds to the recording of RAW moving images and the like, the process proceeds to step S813, and in a case in which it is determined that the current recording format does not correspond to the recording of RAW moving images and the like, the process proceeds to step S812.

In the present embodiment, in a case in which the recording of RAW moving images and the like is selected, it is assumed that electronic image stabilization processing is applied to the moving image with an appropriate strength when moving image editing is performed later (during shooting, display of incomplete information for each angle of view is unnecessary). That is, as a form of notification to the user, a case in which the recording of RAW moving images and the like is performed and a case in which moving-image recording under electronic image stabilization control is performed are exemplified separately.

In step S812, the incomplete information processing unit 112 calculates a frequency at which an out-of-imaging region intrudes into a region corresponding to a recording screen at each angle of view, and executes processing that displays an aggregation result of count values (steps S802, S805, and S808). Since a numerical value representing the frequency is updated for each frame, in a case in which the user is notified of the count value itself in step S802, for example, there is a possibility that changes in the numerical value occur rapidly and are difficult to view. Therefore, there are methods of holding an amount of change in frequency over a certain period, and of providing a hysteresis (threshold) characteristic to an update condition. Additionally, the count value may be normalized by an arbitrary numerical value. In the count value display processing of step S812, the display control unit 113 may be caused to execute processing of drawing an aggregation result (aggregation data) on a display screen of the display unit 114. Examples of displays for notification to the user will be described below with reference to FIG. 12A and FIG. 12B. After step S812, the process proceeds to step S814.

In step S813, the incomplete information processing unit 112 executes icon display processing. Instead of processing for notifying a user of incomplete information regarding electronic image stabilization strength at each angle of view, processing is performed that notifies the user that the collection of incomplete information is currently being performed. Examples of displays for notification to a user will be described below with reference to FIG. 12C. After step S813, the process proceeds to step S814.

In step S814, the incomplete information processing unit 112 determines whether or not a setting to record incomplete information in a file is enabled. In a case in which it is determined that file recording of incomplete information is set to ON, the process proceeds to step S815, and in a case in which it is determined that file recording of incomplete information is set to OFF, the incomplete information processing is completed. Next, in step S815, the processing of acquiring a timestamp of a frame currently being processed is performed. The timestamp is generated based on a time measurement result that is obtained by a timer (not illustrated). The process then proceeds to step S816.

In step S816, the incomplete information processing unit 112 and the CPU 100 perform medium recording control. Recording of incomplete information onto the medium 117 is performed via the recording control unit 116. The medium recording format of the incomplete information may be a text format. A timestamp and a frequency (histogram) regarding the incomplete information are listed. For example, numerical values are described in the order of timestamp, the angle-of-view-A information, the angle-of-view-B information, and the angle-of-view-C information, such as “00:00:08:13, 18, 5, 0.” “00:00:08:13” represents the timestamp (time information), “18” represents a normalized shortage frequency at the angle of view A, “5” represents a normalized shortage frequency at the angle of view B, and “0” represents a normalized shortage frequency at the angle of view C. With respect to the incomplete information, recording may be performed for each frame. Additionally, incomplete information may be recorded for each arbitrary cycle. In that case, an accumulated value of the incomplete information may be recorded. After the processing of step S816, the incomplete information processing is completed.

There is a form in which a file in which incomplete information is recorded is associated, as a file different from a moving image file, with each of a recorded moving image and a proxy moving image. For that purpose, in step S816, the CPU 100 and the recording control unit 116 perform a linking (annotation) process between the recorded moving image file and the recorded file of incomplete information. When the image capturing apparatus 10 performs playback display of a moving image, it is possible to notify a user, on a display screen of a thumbnail image related to the moving image, that a recorded file of incomplete information is present for a file having annotation information. Additionally, in a case in which recording of data such as RAW moving images and the like is performed to an external recording device via the external IF unit 118, only the recorded file of incomplete information is recorded in the medium 117. Location information for a file in which incomplete information is recorded is transferred, as header information, in a transfer data stream to the external recording device. In that case, support is also required on the external recording device side.

With reference to FIG. 12A to FIG. 12C, forms of display for notifying a user will be explained. For example, aggregation data obtained by the aggregation unit 1122 is acquired as histogram data that represents frequencies regarding incomplete information. FIG. 12A to FIG. 12C illustrate examples of notifying a user (photographer) regarding incomplete information during shooting. FIG. 12A and FIG. 12B correspond to display examples of step S812 (count value display processing) of FIG. 11, and FIG. 12C corresponds to a display example of step S813 (icon display processing) of FIG. 11.

FIG. 12A illustrates an example (meter display example) in which frequencies (count values) regarding incomplete information at the angles of view A, B, and C, which are processing results of the incomplete information processing unit 112, are displayed as bar graphs. In a predetermined region of a display screen, histograms of respective frequencies (histograms) regarding incomplete information 901 at the angle of view A, incomplete information 902 at the angle of view B, and incomplete information 903 at the angle of view C are displayed. Although characters “A,” “B,” and “C” in the drawing correspond to the respective angles of view, this is merely an example of graph display. It is also possible to adopt any arbitrary expression method in addition to meter display.

FIG. 12B illustrates an example in which frequencies (count values) regarding incomplete information at the angles of view A, B, and C, which are processing results of the incomplete information processing unit 112, are displayed as numerical values. In a predetermined region of the display screen, respective frequencies regarding incomplete information 904 at the angle of view A, incomplete information 905 at the angle of view B, and incomplete information 906 at the angle of view C are displayed as numerical values. In the case of numerical value display, since the numerical values change for each processing frame and the display may become troublesome, there are methods of performing updating at a rate of once every several seconds and of performing updating in a case in which a numerical value has changed by a predetermined amount by hysteresis. Additionally, a notification form for performing an alert may be adopted in a case in which a state in which the frequency is equal to or greater than an arbitrary threshold continues for a predetermined time (threshold time).

FIG. 12C illustrates an example for notifying a user that incomplete information is being recorded onto the medium 117. An icon 907, which is displayed in a predetermined region of a display screen, is displayed to notify a user that frequencies (aggregation data) representing intrusion of out-of-imaging regions into recorded angles of view for respective electronic image stabilization strengths are currently being recorded. Although the characters “INCMP” that are indicated in the icon 907 represent “incomplete information,” the notification form is not limited thereto. Although the icon display of FIG. 12C is performed, for example, during recording of RAW moving images and the like, it may also be performed in a case in which electronic image stabilization processing is not applied during recording (for example, in a case in which incomplete information at each angle of view is unnecessary for a photographer).

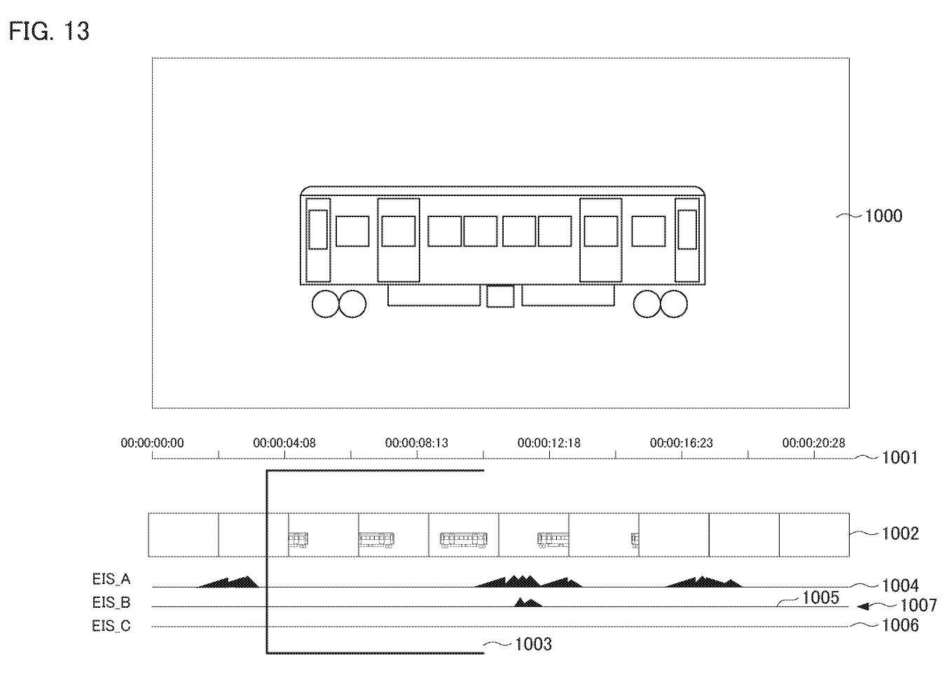

Next, with reference to FIG. 13, an effect of timeline display in an editing tool will be explained. In a case in which the editing tool is provided in the image capturing apparatus 10, it functions as an editing processing unit by a program executed by the CPU 100. Additionally, the editing tool may be provided as an application operating on an external apparatus (such as a PC). As methods of transmission and reception of moving-image recording data, there is a method of performing transmission and reception via the medium 117, and a method of performing transmission and reception between the image capturing apparatus and an external recording device via the external IF unit 118.

In FIG. 13, a display screen 1000 of frame data at an arbitrary time is schematically illustrated. An image of a subject is displayed on the display screen 1000. The arbitrary time corresponds to a time on a timeline display region 1001. For example, a user (editor) can perform an operation to designate an arbitrary time on a time axis by a display line 1003 of a bar display.

In FIG. 13, a plurality of thumbnail images 1002 corresponding to the timeline display region 1001 are displayed. The thumbnail images 1002 are representative images for respective periods. Processing for adjusting a time resolution of the timeline display may be performed. Additionally, as the most detailed setting, a configuration may be adopted in which each thumbnail image is displayable for each frame of moving-image recording data.

EIS_A, EIS_B, and EIS_C in FIG. 13 represent electronic image stabilization strengths. EIS_A corresponds to a recording screen at the angle of view A, EIS_B corresponds to a recording screen at the angle of view B, and EIS_C corresponds to a recording screen at the angle of view C. For example, it is assumed that the electronic image stabilization strength EIS_A is the weakest and the electronic image stabilization strength EIS_C is the strongest. Diagram display regions 1004 to 1006 indicate recording results together with timestamps, showing intrusion conditions of out-of-imaging regions according to electronic image stabilization strengths. An example is shown in which the diagram display regions 1004 to 1006, corresponding to the timeline display region 1001, are displayed to notify a user for each electronic image stabilization strength. As described above, as the electronic image stabilization strength increases, it is necessary to secure a wider margin outside the recorded angle of view, and accordingly, the recorded angle of view is set narrower.

The diagram display regions 1004, 1005, and 1006 of FIG. 13 respectively indicate temporal changes in frequencies of intrusion of out-of-imaging regions into recorded angles of view corresponding to the angles of view A, B, and C in FIG. 10. A pointer display 1007 is illustrated as an example for indicating, on the current display screen 1000, that a recorded image for the angle of view B is displayed. A user can understand that the recorded image for the angle of view B, which corresponds to the display line 1003 on the diagram display region 1005, is displayed on the display screen 1000.

In the example of FIG. 13, it is shown that pixels (insufficient pixels) of an out-of-imaging region exist to some extent in the diagram display region 1004, and that pixels of an out-of-imaging region also partially exist in the diagram display region 1005. Additionally, it is shown that no insufficient pixels exist over the entire period in the diagram display region 1006, and that a recorded image is filled with pixels on an imaging plane. A user (editor) can confirm, on the display screen 1000, a recorded image at a desired time by performing an operation to move the display line 1003 left and right according to a display result of frequency in the diagram display region.

By notification processing to a user in the editing tool, with respect to a moving image file to which electronic image stabilization processing has been applied by the image capturing apparatus 10, it becomes possible to immediately confirm an interpolation state such as interpolation or extrapolation of pixels (insufficient pixels) of an out-of-imaging region. In a case in which there is concern about image quality after interpolation, a user can instruct the image capturing apparatus 10 to perform electronic image stabilization processing again at a changed electronic image stabilization strength. Additionally, in a case of recording RAW moving images and the like, electronic image stabilization processing may be performed later at a setting of EIS_C, which is the strongest electronic image stabilization strength.

Although, in the example of FIG. 13, information for the diagram display regions 1004 to 1006 is output simultaneously for display and recording, a form in which selective display and recording is performed is also possible. For example, there is a method of outputting information for a diagram display region that has been selected from among a plurality of diagram display regions according to an operation instruction from a user. Additionally, there is a method of automatically outputting a diagram that has been selected based on a comparison result between a frequency of intrusion of an out-of-imaging region within a recorded angle of view and a threshold thereof. For example, there is a method of displaying and additionally recording, in a file, information for the frequency (a representative numerical value) and time information (a time stamp) at the time of acquisition, for only frames in which intrusion of an out-of-imaging region within a recorded angle of view has been detected. The time information may be information of elapsed time from a reference time (such as a shooting start time).

Next, with reference to FIG. 14, step S323 (the moving image external recording processing) of FIG. 4 will be explained. The processing of steps S1101 to S1107 respectively is the same as the processing of steps S501 to S507 of FIG. 6 respectively, and therefore an explanation thereof will be omitted. After the processing of step S1107, and in a case in which a negative determination result (an OFF determination of aggregation) is obtained in step S1106, the process proceeds to step S1108.

In step S1108, after codec processing is executed by the codec 115, the process proceeds to step S1109. In step S1109, the CPU 100 executes the processing of transferring data, on which codec processing has been performed, to an external recording device via the external IF unit 118. Monitoring of a communication state may be performed as a function of a separate interrupt handler rather than as a subroutine of FIG. 14. Additionally, in a case in which a communication error occurs, restarting the image capturing apparatus 10 may be performed by separate exception processing. After completion of the processing of step S1109, the moving image external recording processing is completed.

In the present embodiment, although an example of three stages has been explained regarding the setting of electronic image stabilization strength, the number of setting stages is not limited. Notification processing to a user with respect to incomplete information may also be performed for just one stage. The auxiliary information regarding a change in the strength of image blur correction only needs to be information for notifying or recording an intrusion state of an out-of-imaging region into an image region corresponding to a recorded angle of view.

According to the present embodiment, it is possible to provide auxiliary information that enables a user to grasp, from aggregation data, intrusion of an out-of-imaging region (no-image region) into a recorded image (image within a recorded angle of view) caused by electronic image stabilization control, and to change the electronic image stabilization strength to an appropriate strength. As a result, in a case in which a user (photographer) receives a notification, at a shooting site, regarding an intrusion state of an out-of-imaging region into a recorded image, adjustment of the electronic image stabilization strength can be performed on the spot. Additionally, during editing of RAW moving images and the like after recording, in a case in which a user (editor) of an editing tool receives a notification, by timeline display, regarding an intrusion state of an out-of-imaging region into a recorded image, it becomes possible to perform electronic image stabilization processing at an appropriate strength after shooting. It is to be noted that the method of presenting auxiliary information to the user, and the display and recording formats, are not particularly limited, and the specifications thereof may be changed as appropriate.

Although, in the present embodiment, electronic image stabilization control has been explained, an embodiment in which electronic image stabilization control and optical image stabilization control are used in combination may also be adopted. In optical image stabilization control, for example, control is performed to move, in a direction that is parallel to an imaging plane, an optical member (such as a shift lens) that constitutes an image blur correction unit, an imaging element, or both, by a drive mechanism.

According to the present disclosure, in image blur correction based on image processing, it is possible to provide information for notifying or recording an intrusion state of an out-of-imaging region into an image region corresponding to a recorded angle of view.

### Other Embodiments

The present disclosure can also be realized by supplying, to a system or an apparatus, a program for realizing one or more of the functions of above-described embodiments via a network or a storage medium, and by one or more processors in a computer of the system or apparatus reading out and executing the program. Additionally, the present disclosure may be realized by a circuit (for example, an ASIC) that realizes one or more functions.

While embodiments of the present disclosure have been described above, the present disclosure is not limited to these embodiments, and various modifications and changes may be made within the spirit and scope of the present disclosure.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-004818, filed January 14, 2025, which is hereby incorporated by reference herein in its entirety.

What is claimed is:

1. An image capturing apparatus capable of correcting image blur in an image captured by an image capturing device, the image capturing apparatus comprising:
at least one memory storing instructions; and
at least one processor executing the stored instructions causing the image capturing apparatus to:
perform control of image-blur correction by changing a cut-out region of an image on an imaging plane of the image capturing device based on at least one of a detection signal from a detection unit configured to detect a change in position or orientation of the image capturing apparatus, and the image captured by the image capturing device;
in a case in which, as a result of the control of the image-blur correction, an out-of-imaging region is included in an image region corresponding to a recorded angle of view, perform processing for information used when notifying intrusion of the out-of-imaging region into the image region, or when recording the intrusion of the out-of-imaging region into the image region; and
perform control to output, to a display unit, or a recording unit, the information that has been processed with respect to the recorded angle of view according to a strength of the image-blur correction.

2. The image capturing apparatus according to claim 1,
wherein executing the stored instructions by the processor further causes the image capturing apparatus to:
detect a state of the out-of-imaging region that has intruded into the image region; and
perform processing for aggregating information indicating the detected state of the out-of-imaging region.

3. The image capturing apparatus according to claim 2,
wherein executing the stored instructions by the processor further causes the image capturing apparatus to:
perform correction of the captured image by geometric transformation processing; and
perform processing for reconstructing pixels of a recorded image from pixels read out from an image region before the correction.

4. The image capturing apparatus according to claim 3,
wherein executing the stored instructions by the processor further causes the image capturing apparatus to:
read out pixels from the captured image and perform coordinate transformation from the imaging plane to a recorded screen.

5. The image capturing apparatus according to claim 3,
wherein executing the stored instructions by the processor further causes the image capturing apparatus to:
perform processing for counting a number of pixels of the out-of-imaging region.

6. The image capturing apparatus according to claim 5,
wherein executing the stored instructions by the processor further causes the image capturing apparatus to:
count, for each angle of view corresponding to the strength, or for a selected angle of view corresponding to the strength, a number of pixels of the out-of-imaging region, and acquire aggregation data.

7. The image capturing apparatus according to claim 6,
wherein executing the stored instructions by the processor further causes the image capturing apparatus to:
perform control to display, on the display unit, the aggregation data corresponding to the angle of view corresponding to the strength in a form of a graph, or a form of a numerical value, or
perform control to record the aggregation data on the recording unit.

8. The image capturing apparatus according to claim 6,
wherein executing the stored instructions by the processor further causes the image capturing apparatus to:
determine whether or not to execute the processing for aggregating the information indicating the detected state of the out-of-imaging region; and
in a case in which the processing is executed, perform control to display that the aggregation data is being recorded on the display unit.

9. The image capturing apparatus according to claim 6,
wherein executing the stored instructions by the processor further causes the image capturing apparatus to:
perform control to record, on the recording unit, the aggregation data and time information at a point in time when the aggregation data is acquired.

10. The image capturing apparatus according to claim 6,
wherein executing the stored instructions by the processor further causes the image capturing apparatus to:
perform control to, in a case in which the intrusion of the out-of-imaging region into the image region is detected, record, on the recording unit, the processed information and time information at a point in time when the processed information is acquired.

11. The image capturing apparatus according to claim 6,
wherein executing the stored instructions by the processor further causes the image capturing apparatus to:
perform processing of calculating a frequency at which the out-of-imaging region intrudes into the image region corresponding to the angle of view according to the strength, and processing of updating a numerical value representing the frequency for each frame.

12. The image capturing apparatus according to claim 1,
wherein executing the stored instructions by the processor further causes the image capturing apparatus to:
perform processing for associating a first file in which the captured image is recorded with a second file in which the processed information is recorded, and
in a case in which reproduction display of an image related to the first file is performed, perform processing of performing a notification that the second file associated with the first file exists.

13. The image capturing apparatus according to claim 12,
wherein the first file is a file in which a moving image is recorded; and
wherein executing the stored instructions by the processor further causes the image capturing apparatus to:
perform processing for performing a notification on a display screen of a thumbnail image related to the moving image that the second file exists.

14. The image capturing apparatus according to claim 1, further comprising:
the display unit, and the recording unit,
wherein executing the stored instructions by the processor further causes the image capturing apparatus to:
generate, as auxiliary information referenced when changing the strength, information indicating a frequency at which the out-of-imaging region intrudes into an image region corresponding to an angle of view according to the strength; and
perform control to display, on the display unit, an image on which the image-blur correction has been performed and the auxiliary information, or perform control to record, on the recording unit, information of the image on which the image blur correction has been performed and the auxiliary information.

15. A control method executed in an image capturing apparatus capable of correcting image blur in an image captured by an image capturing device, the method comprising:
performing control of image blur correction by changing a cut-out region of an image on an imaging plane of the image capturing device based on at least one of a detection signal from a detection unit configured to detect a change in position or orientation of the image capturing apparatus, and the image captured by the image capturing device;
in a case in which, as a result of the control of the image-blur correction, an out-of-imaging region is included in an image region corresponding to a recorded angle of view, performing processing for information used when notifying intrusion of the out-of-imaging region into the image region, or when recording the intrusion of the out-of-imaging region into the image region; and
performing control to output, to a display unit, or a recording unit, the information that has been processed with respect to the recorded angle of view according to a strength of the image-blur correction.
